(19) United States
(12) Patent Application Publication
(10) Pub. No.: US 2006/0169571 A1
(43) Pub. Date: Aug. 3, 2006

(54) Double clutch transmission

(75) Inventors: Helmut Engelen, Calberlah (DE); Thomas Elfrath, Gifhorn (DE); Roland Denecke, Jerxheim (DE)

Correspondence Address: LERNER GREENBERG STEMER LLP, P O BOX 2480, HOLLYWOOD, FL, 33022-2480, US

(73) Assignee: Volkswagen AG

(21) Appl. No.: 11/290,260

(22) Filed: Nov. 30, 2005

Related U.S. Application Data
(63) Continuation of application No. PCT/EP04/04747, filed on May 5, 2004.

(30) Foreign Application Priority Data
May 30, 2003 (DE) DE 10324467.0

(51) Int. Cl. F16D 13/74

(52) U.S. Cl. 192/107 M; 192/113.34

(57) ABSTRACT

A double clutch drive has two oil-immersed clutches. At least one of the clutches includes at least one wearable element that is partially or wholly composed, at least on the surface area thereof, of carbon-containing material. The assembly is set optimized for a friction factor characteristic. The double clutch drive according to the invention has a friction factor (μ) with respect to a sliding speed (mm/s) that remains positive and continuous.

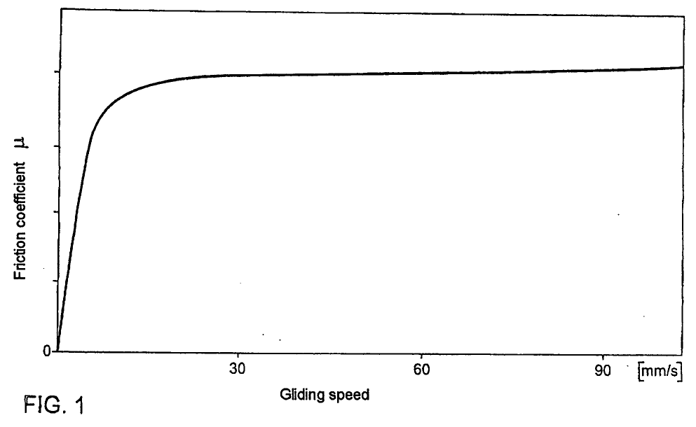

### CROSS-REFERENCE TO RELATED APPLICATION

This is a continuing application, under 35 U.S.C. § 120, of copending international application No. PCT/EP2004/004747, filed May 5, 2004, which designated the United States; this application also claims the priority, under 35 U.S.C. § 119, of German patent application No. 103 24 467.0, filed May 30, 2003; the prior applications are herewith incorporated by reference in their entirety.

### BACKGROUND OF THE INVENTION

### Field of the Invention

The present invention relates to a double clutch transmission, comprising two wet-running clutches. Double clutch transmissions, also referred to as dual clutch or twin clutch transmissions, are a new type of transmission with two usually coaxially arranged transmission input shafts which are assigned in each case a separate friction clutch and a group of gear steps. A primary advantage of the double clutch transmission, as compared with the conventional multi-step change transmission, is the shift operation which is largely free of any interruption in traction and by means of which a better acceleration capacity in a traction mode and a better deceleration capacity in the overrun mode are achieved. An advantage, as compared with a manual shift transmission, is the lower consumption. Owing to the absence of an interruption traction, it is superior to the automated manual shift transmission, but affords the user similar possibilities to an automated transmission.

Commonly assigned patent U.S. Pat. No. 6,722,483 B2, patent application publication US 2003/0024788 A1, and German published patent application DE 101 34 118 A1 describe a twin clutch or double clutch transmission with a dry clutch. The disclosure of the earlier documents are herewith incorporated by reference. Double clutch transmissions with wet clutches which use two multiple-disk clutches running in oil are also already known.

The problem of the hitherto known double clutch transmissions with wet-running clutches is that there are increased requirements as to the lubricants used, which are not fulfilled by the oils normally used for manual shift transmissions. The lubricant requirements are also well above those for conventional multi-step automatic transmission. The double clutch transmission requires, in particular, a very smooth positive friction coefficient profile at gliding speeds of, for example, between 0 and approximately 0.5 m/s, with the result that a sufficient anti-shudder behavior is ensured. The positive friction coefficient profile should persist throughout the useful life of the transmission. It must be remembered, in this context, that considerable temperature differences may arise in the transmission and may amount in the region of the clutch, for example, to between about −40° C. and 180° C. In what are known as hot spots in the multiple-disk assemblies, even temperatures of, for example, above 200° C. may occur.

In order to increase the wear resistance of the stressed components of the double clutch transmission, complicated coating methods have hitherto been necessary or especially hard materials have had to be used. For this purpose, for example, the toothings have been phosphated or otherwise surface-coated, the shift forks have been coated with brass by flame spraying and/or the synchronizing rings have been given a molybdenum coating. Hitherto, therefore, highly complicated measures have been necessary in such a double clutch transmission, in order, inter alia, also to avoid the stick/slip phenomenon, as it is known. In this case, undesirable oscillations which cause noises arise. In the region of the clutches, in previous double clutch transmissions, for example, paper lamellae have been used, although only a comparatively low load-bearing capacity with a Hertzian pressure in a region of, for example, approximately 1 to 1.5 N/mm² can be achieved with these. Furthermore, it must be noted that, in a double clutch transmission, it is necessary, as a rule, to use special transmission oil because of the increased lubricant requirements. On account of the combination of the manual shift transmission with an automatic transmission, on the one hand, the scuffing load capacity, pitting behavior and synchronizing behavior of the manual shift transmission are required and, on the other hand, there are special requirements for the multiple-disk clutch which, moreover, has to be regulated in the microslip range.

The use of materials containing carbon fibers in friction disks is known in principle, from German published patent application and the corresponding patent application publication US 2002/0153214 A1. The friction discs described there consist of composite ceramic material reinforced with carbon fibers and are used primarily as brake disks. The suitability of friction linings of this type for clutch disks is also described. These are, however, what are known as dry clutches, and the materials mentioned in said publication do not come under consideration for wet-running clutches operating with oil. Moreover, the publication makes no reference to clutches in double clutch transmissions, wherein there are the abovementioned specific requirements. Similar materials consisting of a composite ceramic with carbon-containing fibers, which are reaction-bound with a matrix containing one of the elements Si and C, are described in patent U.S. Pat. No. 6,908,667, its corresponding patent application publication US 2003/004050 A1 and German published patent application DE 101 31 758. Insofar as this publication mentions the use of clutch disks, those likewise refer to dry friction clutches.

### SUMMARY OF THE INVENTION

It is accordingly an object of the invention to provide a double clutch transmission, which overcomes the above-mentioned disadvantages of the heretofore-known devices and methods of this general type and wherein the clutches and, if appropriate, further transmission components conform to the above-mentioned complex requirements.

With the foregoing and other objects in view there is provided, in accordance with the invention, a double clutch transmission, comprising two wet-running clutches, at least one of said two clutches and/or the transmission having at least one wear component subject to wear stress and consisting, at least partially and at least in a surface region thereof, of a carbon-containing material.

According to the invention, there is provision for at least one of the clutches and/or the transmission to comprise at least one component which is subjected to wearing stress and which consists at least partially, at least in the surface region, of a carbon-containing material. In a preferred development of the invention, at least the surface of the clutch lamellae consists at least partially of a material which comprises carbon fibers. Said materials containing carbon fibers have, on the one hand, the advantage of high thermal stability. Moreover, the specific load-bearing capacity of materials containing carbon fibers is higher in the region of clutch lamellae than in the case of previous paper linings. This affords the possibility, if appropriate, of reducing the number of friction linings used in a clutch. This makes it possible, in turn, to reduce the overall size of the double clutch transmission. By means of said linings containing carbon fibers, a smooth positive friction coefficient profile can be achieved, particularly at low gliding speed, with the result that a sufficient anti-shudder behavior is ensured.

On account of the high chemical stability of the carbon materials, there is the possibility of increasing the scuffing load capacity and pitting behavior in the mechanical part of the double clutch transmission via the transmission oil. The complicated surface coatings used hitherto, such as phosphating, brass or molybdenum coating or specific materials, may thereby be dispensed with.

According to a preferred development of the invention, not only the surface of the clutch lamellae, but, for example, also synchronizing rings and/or shift tabs of the shift forks, can be produced at least partially from a material containing carbon fibers. In the region of the clutch linings, materials of this type may allow a load-bearing capacity with a Hertzian pressure of more than 2 N/mm², preferably of more than 5 N/mm², further preferably of at least about 10 N/mm² to about 15 N/mm². The number of lamellae used for each clutch can be reduced, for example to less than ten lamellae for each clutch. The carbon-containing material used according to the invention preferably comprises at least partially a material woven from fibers. Alternatively to this or at the same time, for example, materials containing carbon fibers are considered which comprise at least one granulate which may be bound by means of a binder.

For a double clutch transmission (direct shift transmission) according to the invention, preferably lubricants similar in their characteristics to ATF oils are required. The ATF oils (automatic transmission fluid) used according to the invention are preferably fully synthetic oils which, to configure the friction coefficient of the clutch, in particular for achieving a positive friction coefficient profile, contains corresponding additives, in particular friction modifiers. The conventional manual shift transmission oils, as a rule, have not been suitable for double clutch transmissions known hitherto.

For hypoid transmissions, as they are known, that is to say bevel gear axial transmissions with offset axles, which are used, for example, in the rear axle clutch of vehicles, special transmission oils are employed. These are particularly high-alloyed hypoid oils which are required because, during rolling, pronounced sliding movements occur between the tooth flanks touching one another. However, it is difficult, with such hypoid oils, to achieve a positive friction coefficient profile, such as is required in a double clutch transmission of the type according to the invention. The known hypoid oils therefore likewise do not come into consideration as lubricants for a double clutch transmission.

According to the invention, however, manual shift transmission oils with improved friction coefficient behavior on account of the carbon-containing materials used, particularly in the region of the clutch lamellae, may be considered. A manual shift transmission oil or lubricant similar to this should preferably be used, the properties of which correspond at least to the power class GL4 of the API (American Petroleum Institute). Preferably, the transmission oil should correspond at least to the power class GL5 of the API. Furthermore, the transmission oil preferably contains additives which improve the scuffing load capacity and/or the pitting behavior, thereby affording the advantage that specific surface coatings or special materials in the case of the components used in the transmission or in the clutch may be dispensed with. Furthermore, the transmission oil should preferably have a corresponding thermal stability and, for this purpose, may be provided, in particular, with corresponding additives. This ensures sufficient viscosity over the entire temperature range of preferably between about −40° C. and about 180° C. to 200° C. According to a preferred development of the invention, the transmission oil comprises, furthermore, at least one additive for improving the viscosity behavior and/or temperature behavior and/or wear protection behavior and/or oxidation protection behavior and/or foam behavior and/or corrosion protection behavior and/or friction coefficient behavior.

The subject of the present invention is, furthermore, a wet-running clutch or a transmission component for a double clutch transmission, which has the features of one of claims 17 or 18. The subject of the invention is, furthermore, a motor vehicle which, according to claim 19, comprises a double clutch transmission of the abovementioned type.

Other features which are considered as characteristic for the invention are set forth in the appended claims.

Although the invention is illustrated and described herein as embodied in a double clutch transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING FIGURE

The sole FIGURE is a graph illustrating a friction coefficient profile.

### DESCRIPTION OF THE PREFERRED EMBODIMENTS

Referring now to the figure of the drawing in detail, there is shown an exemplary graph of a friction coefficient profile, such as is aimed for in a double clutch transmission according to the invention. In this case, the friction coefficient μ is plotted against the gliding speed [mm/s]. As can be seen, there is a continuously positive friction coefficient profile, with gliding speeds in the range up to 100 mm/s, that is to say approximately 0.1 m/s, being reproduced by way of example in the graph. With an increase in gliding speed, the friction coefficient rises gradually, and only slightly, in the speed range illustrated. There is no maximum in the curve of the friction coefficient profile. A smooth positive friction coefficient profile is thus obtained.

As noted above, additional structural detail may be found in the commonly assigned patent U.S. Pat. No. 6,722,483 B2, patent application publication US 2003/0024788 A1, and German published patent application DE 101 34 118 A1, which are all incorporated by reference herein.

We claim:

1. A double clutch transmission, comprising:
two wet-running clutches, at least one of said two clutches and/or the transmission having at least one wear component subject to wear stress and consisting, at least partially and at least in a surface region thereof, of a carbon-containing material.

2. The double clutch transmission according to claim 1, wherein said clutches are formed with clutch lamellae and at least a surface of said clutch lamellae consists at least partially of a material comprising carbon fibers.

3. The double clutch transmission according to claim 1, wherein synchronizing rings and/or shift tabs of shift forks at least partially comprise, at least in a surface region thereof, of a material containing carbon fibers.

4. The double clutch transmission according to claim 1, which comprises clutch linings formed with a material containing carbon fibers and configured to allow for a load-bearing capacity with a Hertzian pressure of more than 2 N/mm².

5. The double clutch transmission according to claim 1, which comprises clutch linings formed with a material containing carbon fibers and configured to allow for a load-bearing capacity with a Hertzian pressure of more than 5 N/mm².

6. The double clutch transmission according to claim 1, which comprises clutch linings formed with a material containing carbon fibers and configured to allow for a load-bearing capacity with a Hertzian pressure of between about 10 N/mm² and about 15 N/mm².

7. The double clutch transmission according to claim 1, which comprises, in a region of at least one clutch, fewer than ten lamellae.

8. The double clutch transmission according to claim 1, which comprises a material containing carbon fibers formed, at least partially, of a material woven from fibers.

9. The double clutch transmission according to claim 1, which comprises a material containing carbon fibers and formed, at least partially, with a granulate, and optionally bound by a binder.

10. An improved double clutch transmission with at least one wet-running clutch, the improvement which comprises non-conventional oil forming the lubricant.

11. The double clutch transmission according to claim 10 formed with two wet-running clutches according to claim 1.

12. The double clutch transmission according to claim 10, wherein the lubricant is an unconventional ATF oil.

13. The double clutch transmission according to claim 10, wherein the lubricant contains friction modifiers for configuring a friction coefficient of the clutch.

14. The double clutch transmission according to claim 13, wherein said friction modifiers are configured for achieving a positive friction coefficient profile.

15. An improved double clutch transmission with at least one wet-running clutch, the improvement which comprises a lubricant of manual shift transmission oil with improved friction coefficient behavior.

16. The double clutch transmission according to claim 15 formed with two wet-running clutches according to claim 1.

17. The double clutch transmission according to claim 15, wherein said manual shift transmission oil has properties corresponding at a minimum to a power class GL4 of the American Petroleum Institute (API).

18. The double clutch transmission according to claim 17, wherein said transmission oil satisfies at least the power class GL5 of the API.

19. The double clutch transmission according to claim 15, wherein said transmission oil contains additives for improving a load-bearing capacity.

20. The double clutch transmission according to claim 1, which further comprises a transmission oil containing additives for achieving a higher thermal stability.

21. The double clutch transmission according to claim 1, which comprises a transmission oil containing at least one additive for improving at least one property selected from the group consisting of viscosity behavior, temperature behavior, wear protection behavior, oxidation protection behavior, foam behavior, corrosion protection behavior, and friction coefficient behavior.

22. In combination with the double clutch transmission according to claim 1, a wet-running clutch or transmission component for the double clutch transmission.

23. The double clutch transmission according to claim 1 configured to have a positive friction coefficient profile.

24. In combination with a motor vehicle, the double clutch transmission according to claim 1.
